(19) United States
(12) Patent Application Publication
(10) Pub. No.: US 2012/0070658 A1
(43) Pub. Date: Mar. 22, 2012

(54) PRESSURE-SENSITIVE ADHESIVE TAPE

(75) Inventors: Shinsuke IKISHIMA, Ibaraki-shi (JP); Takashi HABU, Ibaraki-shi (JP); Fumiteru ASAI, Ibaraki-shi (JP); Kooki OOYAMA, Ibaraki-shi (JP); Tadao TORII, Ibaraki-shi (JP); Katsutoshi KAMEI, Ibaraki-shi (JP); Yuuki KATOU, Ibaraki-shi (JP); Tomokazu TAKAHASHI, Ibaraki-shi (JP)

(73) Assignee: NITTO DENKO CORPORATION, Osaka (JP)

(21) Appl. No.: 13/232,716

(22) Filed: Sep. 14, 2011

(30) Foreign Application Priority Data
Sep. 16, 2010 (JP) 2010-207826

(51) Int. Cl. C09J 7/02; B29C 47/06

(52) U.S. Cl. 428/354; 264/173.16

(57) ABSTRACT

A pressure-sensitive adhesive tape according to an embodiment of the present invention includes,
a heat-resistant layer;
a base layer; and
a pressure-sensitive adhesive layer in this order, wherein:
the pressure-sensitive adhesive tape has an elastic modulus, i.e., Young's modulus at 25° C. of 150 MPa or less; and
the heat-resistant layer contains a polypropylene-based resin polymerized by using a metallocene catalyst, the polypropylene-based resin having a melting point of 110° C. to 200° C. and a molecular weight distribution “Mw/Mn” of 3 or less.

This application claims priority under 35 U.S.C. Section 119 to Japanese Patent Application No. 2010-207826 filed on Sep. 16, 2010, which are herein incorporated by references.

### BACKGROUND OF THE INVENTION

1. Field of the Invention

The present invention relates to a pressure-sensitive adhesive tape.

2. Description of the Related Art

A semiconductor wafer formed of silicon, gallium, or arsenic is produced as a large-diameter product, and a pattern is formed on its front face. Then, the back face is ground to reduce the thickness of the wafer to usually about 100 to 600 μm, and the wafer is cut and separated into element pieces (dicing), followed by a mounting step.

In the step of grinding the back face of the semiconductor wafer (back face-grinding step), a pressure-sensitive adhesive tape is used to protect the pattern surface of the semiconductor wafer. The pressure-sensitive adhesive tape is eventually peeled off. The pressure-sensitive adhesive tape used for such purpose is required to have an adhesion enough not to peel off during the back face-grinding step but is required to have a low adhesion so that the tape is easily peeled off after the back face-grinding step and does not to break the semiconductor wafer.

Further, in recent years, in order to improve handling property of a semiconductor wafer ground to be thinner, a technology for completing steps from the back face-grinding step to the completion of a dicing step in line has been used. In such technology, a dicing die attach film having both functions of fixing a semiconductor wafer in dicing and bonding an element piece obtained by dicing onto a substrate or the like is usually attached on the back face of a semiconductor wafer on which the above-mentioned pressure-sensitive adhesive tape has been attached (the surface opposite to the surface on which the pressure-sensitive adhesive tape is attached) after the back face-grinding step. In the attachment, the semiconductor wafer on which the pressure-sensitive adhesive tape has been attached is placed on a heating table so that the pressure-sensitive adhesive tape side is a contact surface, and heated to about 100° C. Therefore, the above-mentioned pressure-sensitive adhesive tape is required to have heat resistance, specifically not to fuse on the heating table in heating.

Conventionally, as the pressure-sensitive adhesive tape, a pressure-sensitive adhesive tape including a base material coated with a pressure-sensitive adhesive has been used. For example, there has been proposed a pressure-sensitive adhesive tape including a pressure-sensitive adhesive layer obtained by applying an acrylic pressure-sensitive adhesive on a base material containing a polyethylene-based resin (WO 2007/116856). However, the production of such pressure-sensitive adhesive tape requires many steps such as the step of forming the base material into a film and the step of applying a pressure-sensitive adhesive solution, and hence the tape is expensive to produce. Moreover, there is a problem of a large amount of exhaust CO₂. In addition, in the above-mentioned production method, it is necessary to remove an organic solvent after application of the pressure-sensitive adhesive solution by drying, and hence there is a problem of an environmental burden due to volatilization of the organic solvent.

As a method of solving such problems, there is given a method including performing coextrusion of a base material-forming material and a pressure-sensitive adhesive-forming material. However, materials which may be subjected to the coextrusion are thermoplastic resins, and in the case of using a thermoplastic acrylic resin, a thermoplastic styrene-based resin, or the like as the pressure-sensitive adhesive-forming material, there is a problem in that an impurity derived from the pressure-sensitive adhesive may contaminate the semiconductor wafer. In particular, when an ion generated in polymerization of a resin for constructing the pressure-sensitive adhesive (for example, an ion derived from a catalyst) remains in the pressure-sensitive adhesive layer and contaminates a wafer circuit, a trouble such as disconnection or short of the circuit may be caused. It is difficult to solve such contamination problems and to produce a pressure-sensitive adhesive tape which satisfies such heat resistance as described above.

### SUMMARY OF THE INVENTION

The present invention has been made to solve the above-mentioned conventional problems, and an object of the present invention is to provide a pressure-sensitive adhesive tape having excellent heat resistance, that is, a pressure-sensitive adhesive tape having a surface which is difficult to melt after attachment.

A pressure-sensitive adhesive tape according to an embodiment of the present invention includes,

a heat-resistant layer;

a base layer; and

a pressure-sensitive adhesive layer in this order, wherein:

the pressure-sensitive adhesive tape has an elastic modulus, i.e., Young's modulus at 25° C. of 150 MPa or less; and

the heat-resistant layer contains a polypropylene-based resin polymerized by using a metallocene catalyst, the polypropylene-based resin having a melting point of 110° C. to 200° C. and a molecular weight distribution “Mw/Mn” of 3 or less.

In a preferred embodiment of the present invention, the pressure-sensitive adhesive tape further includes a second heat-resistant layer between the base layer and the pressure-sensitive adhesive layer.

In a preferred embodiment of the present invention, the heat-resistant layer is substantially free of F⁻, Cl⁻, Br⁻, NO₂⁻, NO₃⁻, SO₄²⁻, Li⁺, Na⁺, K⁺, Mg²⁺, Ca²⁺, and NH₄⁺.

In a preferred embodiment of the present invention, the pressure-sensitive adhesive tape is obtained by coextrusion molding of a heat-resistant layer-forming material, a base layer-forming material, and a pressure-sensitive adhesive layer-forming material.

In a preferred embodiment of the present invention, the pressure-sensitive adhesive tape is used for processing a semiconductor wafer.

According to the present invention, it is possible to provide a pressure-sensitive adhesive tape which is excellent in heat resistance because the tape includes the heat-resistant layer containing a specific polypropylene-based resin. Such pressure-sensitive adhesive tape is particularly suitable as a pressure-sensitive adhesive tape for processing a semiconductor wafer to be subjected to a heating step. Moreover, according to the present invention, it is possible to provide a pressure-sensitive adhesive tape which can be produced in few steps without using an organic solvent because the tape is produced by coextrusion molding.

### BRIEF DESCRIPTION OF THE DRAWINGS

In the accompanying drawings:

FIG. 1 is a schematic cross-sectional view of a laminated film according a preferred embodiment of the present invention;

FIG. 2 is a schematic cross-sectional view of a laminated film according another preferred embodiment of the present invention; and

FIG. 3 is a view for describing a “peeling width” used as an index of step following property of a pressure-sensitive adhesive tape of the present invention.

### DETAILED DESCRIPTION OF THE PREFERRED EMBODIMENTS

A. Entire construction of pressure-sensitive adhesive tape

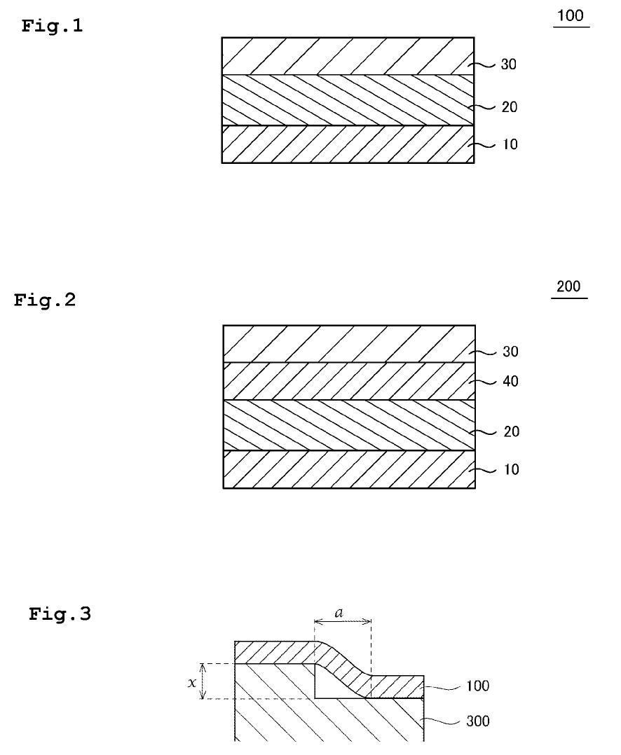

FIG. 1 is a schematic cross-sectional view of a pressure-sensitive adhesive tape according to a preferred embodiment of the present invention. The pressure-sensitive adhesive tape 100 includes a heat-resistant layer 10, a base layer 20, and a pressure-sensitive adhesive layer 30 in this order. The heat-resistant layer 10 contains a polypropylene-based olefin resin. The heat-resistant layer 10, base layer 20, and pressure-sensitive adhesive layer 30 are preferably formed by coextrusion molding.

FIG. 2 is a schematic cross-sectional view of a pressure-sensitive adhesive tape according to another preferred embodiment of the present invention. A pressure-sensitive adhesive tape 200 includes a second heat-resistant layer 40 between the base layer 20 and the pressure-sensitive adhesive layer 30. If the tape includes the second heat-resistant layer 40, the heat resistance of the pressure-sensitive adhesive tape can further be enhanced. Moreover, if the tape includes the second heat-resistant layer 40, the elastic modulus of the pressure-sensitive adhesive tape can be adjusted.

The pressure-sensitive adhesive tape of the present invention has a thickness of preferably 90 μm to 285 μm, more preferably 105 μm to 225 μm, particularly preferably 130 μm to 205 μm.

In the case where the pressure-sensitive adhesive tape of the present invention does not include the second heat-resistant layer, the thickness of the heat-resistant layer is preferably 10 μm to 60 μm, more preferably 15 μm to 50 μm, particularly preferably 15 μm to 30 μm. In the case where the pressure-sensitive adhesive tape of the present invention includes the second heat-resistant layer, the thickness of the heat-resistant layer is preferably 10 μm to 60 μm, more preferably 15 μm to 50 μm, particularly preferably 15 μm to 30 μm. The thickness of the second heat-resistant layer is preferably 10 μm to 60 μm, more preferably 15 μm to 50 μm, particularly preferably 15 μm to 30 μm.

In one embodiment, in the case where the pressure-sensitive adhesive tape of the present invention includes the second heat-resistant layer, the total thickness of the heat-resistant layer and the second heat-resistant layer is preferably 30 μm or less, more preferably 20 μm or less. If the total thickness of the heat-resistant layer and the second heat-resistant layer is in such range, a pressure-sensitive adhesive tape having excellent flexibility can be obtained even if a resin having high strength is used as a material for forming the heat-resistant layer and/or the second heat-resistant layer.

The above-mentioned base layer has a thickness of preferably 30 μm to 185 μm, more preferably 65 μm to 175 μm.

The above-mentioned pressure-sensitive adhesive layer has a thickness of preferably 20 μm to 100 μm, more preferably 30 μm to 65 μm.

In the case where the pressure-sensitive adhesive tape of the present invention does not include the second heat-resistant layer, a thickness ratio between the base layer and the heat-resistant layer (base layer/heat-resistant layer) is preferably 0.5 to 20, more preferably 1 to 15, particularly preferably 1.5 to 10, more particularly preferably 2 to 10. In the case where the pressure-sensitive adhesive tape of the present invention includes the second heat-resistant layer, the thickness ratio between the base layer and the heat-resistant layer (base layer/heat-resistant layer) is preferably 1 to 20, more preferably 1 to 10, particularly preferably 2 to 10. Meanwhile, in the case where the pressure-sensitive adhesive tape of the present invention includes the second heat-resistant layer, the ratio of the thickness of the base layer to the total thickness of the heat-resistant layer and the second heat-resistant layer (base layer/(heat-resistant layer+second heat-resistant layer)) is preferably 0.5 to 15, more preferably 1 to 10, particularly preferably 1 to 5. If the ratio is in such range, a pressure-sensitive adhesive tape which has both excellent flexibility and excellent heat resistance, is excellent in processability, and hardly causes appearance failures can be obtained. In the case where such pressure-sensitive adhesive tape is used as, for example, a pressure-sensitive adhesive tape for processing a semiconductor wafer, it is possible to prevent damage in the wafer (crack in the wafer edge) due to contact with the pressure-sensitive adhesive tape in the back face-grinding step for the wafer.

In the case where the pressure-sensitive adhesive tape of the present invention includes the second heat-resistant layer, a thickness ratio between the heat-resistant layer and the second heat-resistant layer (heat-resistant layer/second heat-resistant layer) is preferably 0.3 to 3, more preferably 0.8 to 1.5, particularly preferably 0.9 to 1.1. If the ratio is in such range, a pressure-sensitive adhesive tape having excellent flexibility can be obtained. In the case where such pressure-sensitive adhesive tape is used as, for example, a pressure-sensitive adhesive tape for processing a semiconductor wafer, it is possible to prevent damage in the wafer (crack in the wafer edge) due to contact with the pressure-sensitive adhesive tape in the back face-grinding step for the wafer.

The pressure-sensitive adhesive tape of the present invention has an elastic modulus (Young's modulus) at 25° C. of 150 MPa or less, preferably 50 MPa to 120 MPa, more preferably 60 MPa to 100 MPa. If the elastic modulus is in such range, a pressure-sensitive adhesive tape having excellent flexibility can be obtained. In the case where such pressure-sensitive adhesive tape is used as, for example, a pressure-sensitive adhesive tape for processing a semiconductor wafer, it is possible to prevent damage in the wafer due to contact with the pressure-sensitive adhesive tape in the back face-grinding step for the wafer. As described above, according to the present invention, it is possible to obtain a pressure-sensitive adhesive tape which has heat resistance given by forming the heat-resistant layer and has excellent flexibility. It should be noted that, in this specification, the elastic modulus (Young's modulus) refers to a value calculated from a slope of the maximum tangent in a stress-strain (S-S) curve obtained by stretching a strip-shaped pressure-sensitive adhesive sheet with a width of 10 mm at 23° C., a distance between chucks of 50 mm, and a rate of 300 mm/min.

The pressure-sensitive adhesive tape of the present invention has an adhesion of preferably 0.3 N/20 mm to 3.0 N/20 mm, more preferably 0.4 N/20 mm to 2.5 N/20 mm, particularly preferably 0.4 N/20 mm to 2.0 N/20 mm, which is measured by a method according to JIS Z 0237 (2000) (attaching conditions: turning a 2-kg roller one round, peeling rate: 300 mm/min, peeling angle: 180°) using a semiconductor mirror wafer as a test plate (made of silicon). If the adhesion is in such range, it is possible to obtain a pressure-sensitive adhesive tape which is excellent in both adhesion and peeling property and hence, for example, does not peel off during grinding processing in the back face-grinding step for a semiconductor wafer and can be easily peeled off after grinding processing. In order to obtain the pressure-sensitive adhesive tape having such adhesion, for example, the adhesion can be exhibited by blending an amorphous propylene-(1-butene) copolymer as a major component in the pressure-sensitive adhesive layer and can be adjusted by adding a crystalline polypropylene-based resin. Details of components in the pressure-sensitive adhesive layer are described below.

In the case where the pressure-sensitive adhesive tape of the present invention is attached on the mirror surface of a 4-inch semiconductor wafer and peeled off after a lapse of 1 hour under an environment of a temperature of 23° C. and a relative humidity of 50%, the number of particles each having a particle size of 0.28 μm or more on the mirror surface is preferably 1 particle/cm² to 500 particles/cm², more preferably 1 particle/cm² to 100 particles/cm², particularly preferably 1 particle/cm² to 50 particles/cm², most preferably 0 particle/cm² to 20 particles/cm². The number of particles can be measured by a particle counter.

In this specification, a “peeling width” is used as an index of step following property of the pressure-sensitive adhesive tape. As shown in FIG. 3, the term “peeling width” refers to, in the case where a pressure-sensitive adhesive tape 100 is attached on an adherend 300 having a step x, a width a of a part which does not contact with the adherend 300 because the pressure-sensitive adhesive tape is not attached. The peeling width of the pressure-sensitive adhesive tape of the present invention with respect to an adherend having a step of 3.5 μm immediately after attachment is preferably 10 μm to 200 μm, more preferably 20 μm to 180 μm, particularly preferably 30 μm to 150 μm. The pressure-sensitive adhesive tape having a peeling width in such range can follow an adherend having irregularities (for example, irregularities of a semiconductor wafer pattern) well, and has excellent adhesion. Moreover, in the case where the pressure-sensitive adhesive tape of the present invention is used for processing a semiconductor wafer, it is possible to prevent invasion of grinding water into an interface between the semiconductor wafer and the pressure-sensitive adhesive tape in the back face-grinding step.

In the case where the pressure-sensitive adhesive tape of the present invention is attached on a semiconductor mirror wafer (made of silicon), an increment of the peeling width with respect to a step of 30 μm from immediately after attachment to after a lapse of 24 hours is preferably 40% or less, more preferably 20% or less, particularly preferably 10% or less. A pressure-sensitive adhesive tape which exhibits such increment of the peeling width, that is, a pressure-sensitive adhesive tape which exhibits a small change with time in adhesion is excellent in storage stability and processing stability in production, for example, hardly causing a tape peeling part in a product in process with time in production of a semiconductor wafer.

The pressure-sensitive adhesive tape of the present invention may be provided while being protected with a separator. The pressure-sensitive adhesive tape of the present invention can be wound in a roll shape in a state of being protected with the separator. The separator has a function as a protective material for protecting the pressure-sensitive adhesive tape of the present invention before the tape is put into practical use. Examples of the separator include a plastic (for example, polyethylene terephthalate (PET), polyethylene, or polypropylene) film, paper, and nonwoven fabric whose surfaces are coated with releasing agents such as a silicone-based releasing agent, a fluorine-based releasing agent, and a long-chain alkyl acrylate-based releasing agent.

In, for example, the case where the pressure-sensitive adhesive tape of the present invention is not protected with the separator, the outermost layer on the side opposite to the pressure-sensitive adhesive layer of the tape may be subjected to a back surface treatment. The back surface treatment can be performed with, for example, a releasing agent such as a silicone-based releasing agent or a long-chain alkyl acrylate-based releasing agent. When the pressure-sensitive adhesive tape of the present invention is subjected to the back surface treatment, the tape can be wound in a roll shape.

B. Heat-Resistant Layer and Second Heat-Resistant Layer

The above-mentioned heat-resistant layer and second heat-resistant layer each contain a polypropylene-based resin.

The above-mentioned polypropylene-based resin can be obtained by polymerization using a metallocene catalyst. More specifically, the polypropylene-based resin can be obtained by performing, for example: a polymerization step of polymerizing a monomer composition containing propylene by using the metallocene catalyst; and then after-treatment steps such as the step of removing a catalyst residue and the step of removing foreign matter. The polypropylene-based resin is obtained by such steps in a form of, for example, powder or pellet. Examples of the metallocene catalyst include a metallocene-uniformly-mixed catalyst including a metallocene compound and aluminoxane and a metallocene-carrying catalyst including a metallocene compound carried on a particulate carrier.

The polypropylene-based resin polymerized by using the metallocene catalyst as described above has a narrow molecular weight distribution. Specifically, the above-mentioned polypropylene-based resin has a molecular weight distribution (Mw/Mn) of 3 or less, preferably 1.1 to 3, more preferably 1.2 to 2.9. A polypropylene-based resin having a narrow molecular weight distribution contains low-molecular-weight components in small amounts. Therefore, when such polypropylene-based resin is used, a pressure-sensitive adhesive tape capable of preventing bleeding of the low-molecular-weight components and excellent in cleanness can be obtained. Such pressure-sensitive adhesive tape is suitably used for processing a semiconductor wafer, for example.

The above-mentioned polypropylene-based resin has a weight-average molecular weight (Mw) of 50,000 or more, preferably 50,000 to 500,000, more preferably 50,000 to 400,000. If the weight-average molecular weight (Mw) of the polypropylene-based resin is in such range, a pressure-sensitive adhesive tape capable of preventing bleeding of the low-molecular-weight components and excellent in cleanness can be obtained. Such pressure-sensitive adhesive tape is suitably used as a pressure-sensitive adhesive tape for processing a semiconductor wafer, for example.

The above-mentioned polypropylene-based resin has a melting point of 110° C. to 200° C., more preferably 120° C. to 170° C., particularly preferably 125° C. to 160° C. If the melting point is in such range, a pressure-sensitive adhesive tape having excellent heat resistance can be obtained. The pressure-sensitive adhesive tape of the present invention includes the heat-resistant layer containing the polypropylene-based resin having a melting point in such range, and hence the pressure-sensitive adhesive tape has heat resistance, and specifically, its surface is difficult to melt even if the tape is heated after attachment. Such pressure-sensitive adhesive tape is particularly useful when the tape is subjected to contact heating. For example, in the case where the pressure-sensitive adhesive tape is used as a pressure-sensitive adhesive tape for processing a semiconductor wafer, the surface of the pressure-sensitive adhesive tape is difficult to fuse on a heating stage of a device for producing a semiconductor, resulting in preventing processing failures. Further, the pressure-sensitive adhesive tape of the present invention has not only excellent heat resistance but also excellent flexibility as described above. Such pressure-sensitive adhesive tape excellent in a balance between the heat resistance and flexibility is useful as, for example, a pressure-sensitive adhesive tape for processing a semiconductor wafer. More specifically, the tape is useful as a pressure-sensitive adhesive tape for processing a semiconductor wafer to be used in a production method in which steps from the bake face-grinding step to the completion of the dicing step are performed in line (so-called 2-in-1 production method). In such production method, the pressure-sensitive adhesive tape is subjected continuously to the bake face-grinding step and the dicing step. If the pressure-sensitive adhesive tape of the present invention is used as a pressure-sensitive adhesive tape for processing a semiconductor wafer in the 2-in-1 production method, even if the pressure-sensitive adhesive tape has contact with a heating table (for example, 100° C.) when a dicing film (or a dicing die attach film) is attached on the back face of a semiconductor wafer including the pressure-sensitive adhesive tape, it is possible to prevent fusion of the pressure-sensitive adhesive tape surface on the heating table and to prevent damage of the semiconductor wafer due to the contact with the pressure-sensitive adhesive tape.

The above-mentioned polypropylene-based resin has a softening point of preferably 100° C. to 170° C., more preferably 110° C. to 160° C., still more preferably 120° C. to 150° C. If the softening point is in such range, a pressure-sensitive adhesive tape having excellent heat resistance can be obtained. It should be noted that, in this specification, the softening point refers to a value measured by a ring-and-ball method (JIS K 6863).

The above-mentioned polypropylene-based resin has a melt flow rate at 230° C. and 2.16 kgf of preferably 3 g/10 min to 30 g/10 min, more preferably 5 g/10 min to 15 g/10 min, particularly preferably g/10 min to 10 g/10 min. If the melt flow rate of the polypropylene-based resin is in such range, a heat-resistant layer having a uniform thickness can be formed by coextrusion molding without processing failures. The melt flow rate can be measured by a method according to JIS K 7210.

As long as the effects of the present invention are not impaired, the above-mentioned polypropylene-based resin may also include a constituent unit derived from any other monomer. Examples of other monomer include α-olefins such as ethylene, 1-pentene, 1-hexene, 1-octene, 1-decene, 4-methyl-1-pentene, and 3-methyl-1-pentene. When the polypropylene-based resin include a constituent unit derived from the other monomer, the resin may be a block copolymer or a random copolymer.

The above-mentioned polypropylene-based resin may be a commercially available product. Specific examples of the commercially available polypropylene-based resin include a series of products manufactured by Japan Polypropylene Corporation (product names “WINTEC” and “WELNEX”).

Preferably, the heat-resistant layer and second heat-resistant layer described above are substantially free of F⁻, Cl⁻, Br⁻, NO₂⁻, NO₃⁻, SO₄²⁻, Li⁺, Na⁺, K⁺, Mg²⁺, Ca²⁺, and NH₄⁺. For example, in the case where a pressure-sensitive adhesive tape including a heat-resistant layer substantially free of such ions, which is excellent in cleanness, is used for processing a semiconductor wafer, disconnection or short of a circuit or the like can be prevented. It should be noted that, in this specification, the phrase “substantially free of F⁻, Cl⁻, Br⁻, NO₂⁻, NO₃⁻, SO₄²⁻, Li⁺, Na⁺, K⁺, Mg²⁺, Ca²⁺, and NH₄⁺” means that concentrations of the ions, measured by a standard ion chromatography analysis (for example, an ion chromatography analysis using a device manufactured by DIONEX, product name “DX-320” or “DX-500”), are lower than detection limits. Specifically, the phrase means that 1 g of the pressure-sensitive adhesive layer contains 0.49 μg or less of each of F⁻, Cl⁻, Br⁻, NO₂⁻, NO₃⁻, SO₄²⁻, and K⁺, 0.20 μg or less of each of Li⁺ and Na⁺, 0.97 μg or less of each of Mg²⁺ and Ca²⁺, and 0.5 μg or less of NH₄⁺.

The elastic modulus (Young's modulus) of each of the heat-resistant layer and second heat-resistant layer described above can be adjusted to any appropriate value depending on a desired elastic modulus (Young's modulus) of the pressure-sensitive adhesive tape and properties of the pressure-sensitive adhesive layer and base payer (thickness, elastic modulus (Young's modulus)). The elastic modulus (Young's modulus) at 25° C. of each of the heat-resistant layer and second heat-resistant layer described above is typically 800 MPa or less, more preferably 50 MPa to 500 MPa, particularly preferably 50 MPa to 250 MPa. If the modulus is in such range, in the case of using the pressure-sensitive adhesive tape of the present invention as a pressure-sensitive adhesive tape for processing a semiconductor wafer, it is possible to provide excellent grinding accuracy in the back face-grinding step for the wafer and to prevent damage in the wafer edge (crack in the wafer edge).

The heat-resistant layer and second heat-resistant layer described above may each further contain any other component as long as the effects of the present invention are not impaired. Examples of the other component include an antioxidant, a UV absorbing agent, a light stabilizer, a heat stabilizer, and an antistat. The type and usage of the other component may be appropriately selected depending on purposes.

C. Pressure-Sensitive Adhesive Layer

As a pressure-sensitive adhesive to be used in the above-mentioned pressure-sensitive adhesive layer, any appropriate material may be used. The material is preferably a thermoplastic resin capable of being subjected to coextrusion molding, and examples thereof include an amorphous propylene-(1-butene) copolymer. In this specification, the term “amorphous” refers to property of not having a clear melting point unlike a crystalline material.

The above-mentioned amorphous propylene-(1-butene) copolymer can be obtained preferably by polymerizing propylene and 1-butene by using a metallocene catalyst. The amorphous propylene-(1-butene) copolymer polymerized by using the metallocene catalyst has a narrow molecular weight distribution (for example, 2 or less). Therefore, when such amorphous propylene-(1-butene) copolymer is used, a pressure-sensitive adhesive tape capable of preventing contamination of an adherend by bleeding of low-molecular-weight components can be obtained. Such pressure-sensitive adhesive tape is suitably used for processing a semiconductor wafer, for example.

The content of a constituent unit derived from propylene in the above-mentioned amorphous propylene-(1-butene) copolymer is preferably 80 mol % to 99 mol %, more preferably 85 mol % to 99 mol %, particularly preferably 90 mol % to 99 mol %.

The content of a constituent unit derived from 1-butene in the above-mentioned amorphous propylene-(1-butene) copolymer is preferably 1 mol % to 15 mol %, more preferably 1 mol % to 10 mol %. If the contents are in such ranges, a pressure-sensitive adhesive tape which is excellent in a balance between toughness and flexibility and in which the above-mentioned peeling width is small can be obtained.

The above-mentioned amorphous propylene-(1-butene) copolymer may be a block copolymer or a random copolymer.

The above-mentioned amorphous propylene-(1-butene) copolymer has a weight-average molecular weight (Mw) of preferably 200,000 or more, more preferably 200,000 to 500,000, particularly preferably 200,000 to 300,000. If the weight-average molecular weight (Mw) of the amorphous propylene-(1-butene) copolymer is in such range, it is possible to form the pressure-sensitive adhesive layer without processing failures in coextrusion molding and to provide an appropriate adhesion.

In the case where the above-mentioned pressure-sensitive adhesive layer contains amorphous propylene-(1-butene), the above-mentioned pressure-sensitive adhesive layer may contain a crystalline polypropylene-based resin to adjust the adhesion of the pressure-sensitive adhesive layer (as a result, the adhesion of the above-mentioned pressure-sensitive adhesive tape). When the pressure-sensitive adhesive layer contains the crystalline polypropylene-based resin, it is possible to decrease the above-mentioned adhesion and to increase the after-mentioned storage elastic modulus. The content of the crystalline polypropylene-based resin may be adjusted to any appropriate ratio depending on the desired adhesion and storage elastic modulus. The content of the crystalline polypropylene-based resin is preferably 0 wt % to 50 wt %, more preferably 0 wt % to 40 wt %, particularly preferably 0 wt % to 30 wt % with respect to the total weight of the above-mentioned amorphous propylene-(1-butene) copolymer and the crystalline polypropylene-based resin.

The pressure-sensitive adhesive to be used in the above-mentioned pressure-sensitive adhesive layer has a melt flow rate at 230° C. and 2.16 kgf of preferably 1 g/10 min to 50 g/10 min, more preferably 5 g/10 min to 30 g/10 min, particularly preferably g/10 min to 20 g/10 min. If the melt flow rate of the pressure-sensitive adhesive is in such range, a pressure-sensitive adhesive layer having a uniform thickness can be formed by coextrusion molding without processing failures.

Preferably, the above-mentioned pressure-sensitive adhesive layer is substantially free of F⁻, Cl⁻, Br⁻, NO₂, NO₃, SO₄²⁻, Li⁺, Na⁺, K⁺, Mg²⁺, Ca²⁺, and NH₄⁺ because it is possible to prevent contamination of an adherent with such ions. For example, in the case where a pressure-sensitive adhesive tape including such pressure-sensitive adhesive layer is used for processing a semiconductor wafer, disconnection or short of a circuit or the like does not occur. The pressure-sensitive adhesive layer free of the above-mentioned ions can be obtained by, for example, solution polymerization of the amorphous propylene-(1-butene) copolymer in the pressure-sensitive adhesive layer using the metallocene catalyst as described above. In the solution polymerization using the metallocene catalyst, the amorphous propylene-(1-butene) copolymer can be purified by repeating precipitation and isolation (reprecipitation) using a poor solvent different from a solvent used in polymerization, and hence the pressure-sensitive adhesive layer free of the above-mentioned ions can be obtained.

The storage elastic modulus (G′) of the above-mentioned pressure-sensitive adhesive layer is preferably 0.5×10⁶ Pa to 1.0×10⁸ Pa, more preferably 0.8×10⁶ Pa to 3.0×10⁷ Pa. If the storage elastic modulus (G′) of the above-mentioned pressure-sensitive adhesive layer is in such range, it is possible to obtain a pressure-sensitive adhesive tape having both a sufficient adhesion and appropriate peeling property for an adherend having irregularities on its surface. Further, in the case where the pressure-sensitive adhesive tape including the above-mentioned pressure-sensitive adhesive layer having such storage elastic modulus (G′) is used for processing a semiconductor wafer, the tape may contribute to achievement of excellent grinding accuracy in grinding of the back face of the wafer. The storage elastic modulus of the pressure-sensitive adhesive layer can be controlled by, for example, adjusting a content ratio between the above-mentioned amorphous propylene-(1-butene) copolymer and the above-mentioned crystalline polypropylene-based resin. It should be noted that the storage elastic modulus (G′) in the present invention can be measured by dynamic viscoelasticity spectrum measurement.

The elastic modulus (Young's modulus) at 25° C. of the above-mentioned pressure-sensitive adhesive layer is preferably 5 MPa to 300 MPa, more preferably 10 MPa to 200 MPa, particularly preferably 20 MPa to 100 MPa. If the modulus is in such range, in the case of using the pressure-sensitive adhesive tape of the present invention as a pressure-sensitive adhesive tape for processing a semiconductor wafer, it is possible to provide excellent grinding accuracy in the back face-grinding step for the wafer and to prevent damage in the wafer edge (crack in the wafer edge).

The above-mentioned pressure-sensitive adhesive layer may further contain any other component as long as the effects of the present invention are not impaired. Examples of the other component include the same components as those described in the above-mentioned section B as components which may be contained in the heat-resistant layer.

D. Base Layer

The above-mentioned base layer is formed by any appropriate resin. The resin is preferably a thermoplastic resin capable of being subjected to coextrusion molding, such as a polyethylene-based resin. Specific examples of the polyethylene-based resin include an ethylene-vinyl acetate copolymer.

The above-mentioned ethylene-vinyl acetate copolymer has a weight-average molecular weight (Mw) of preferably 10,000 to 200,000, more preferably 30,000 to 190,000. If the weight-average molecular weight (Mw) of the ethylene-vinyl acetate copolymer is in such range, it is possible to form the base layer without processing failures in coextrusion molding.

The above-mentioned resin for forming the base layer has a melt flow rate at 190° C. and 2.16 kgf of preferably 2 g/10 min to 20 g/10 min, more preferably 5 g/10 min to 15 g/10 min, particularly preferably 7 g/10 min to 12 g/10 min. If the melt flow rate of the ethylene-vinyl acetate copolymer is in such range, it is possible to form the base layer without processing failures by coextrusion molding.

The elastic modulus (Young's modulus) at 25° C. of the above-mentioned base layer is preferably 30 MPa to 300 MPa, more preferably 40 MPa to 200 MPa, particularly preferably 50 MPa to 100 MPa. If the modulus is in such range, in the case of using the pressure-sensitive adhesive tape of the present invention as a pressure-sensitive adhesive tape for processing a semiconductor wafer, it is possible to provide excellent grinding accuracy in the back face-grinding step for the wafer and to prevent damage in the wafer edge (crack in the wafer edge).

The above-mentioned base layer may further contain any other component as long as the effects of the present invention are not impaired. Examples of the other component include the same components as those described in the above-mentioned section B as components which may be contained in the heat-resistant layer.

E. Method of PRODUCING PRESSURE-SENSITIVE ADHESIVE TAPE

The pressure-sensitive adhesive tape of the present invention is preferably produced by coextrusion molding of forming materials for the above-mentioned heat-resistant layer, the above-mentioned base layer, and the above-mentioned pressure-sensitive adhesive layer. The coextrusion molding enables production of a pressure-sensitive adhesive tape having good adhesion property between layers in few steps without using an organic solvent.

In the above-mentioned coextrusion molding, the forming materials for the above-mentioned heat-resistant layer, the above-mentioned base layer, and the above-mentioned pressure-sensitive adhesive layer may be materials obtained by mixing the above-mentioned components of the respective layers by any appropriate method.

A specific method for the above-mentioned coextrusion molding is, for example, a method including: supplying the heat-resistant layer-forming material, the base layer-forming material, and the pressure-sensitive adhesive layer-forming material separately to different extruders of three extruders connected to dies; melting and extruding the materials; and collecting the resultant products by a touch-roll molding method to mold a laminate. It should be noted that, in the case where the pressure-sensitive adhesive tape of the present invention further includes the second heat-resistant layer, three-type four-layer molding which is a method including dividing a resin flow path where a resin for the heat-resistant layer is extruded of three extruders into two paths and mixing a resin for the base layer in a space between the divided paths, or four-type four-layer molding using four extruders may be employed. In the extrusion, a confluence part of the forming materials is preferably close to outlets of the dies (die slips). This is because such structure can prevent confluence failures of the forming materials in the dies. Therefore, as the above-mentioned dies, multi-manifold-system dies are preferably used. It should be noted that the case where the confluence failures are caused is not preferred because appearance failures due to irregular confluence or the like, specifically, wavelike appearance irregularities between the pressure-sensitive adhesive layer and the base layer extruded are caused. Further, the confluence failures are caused by, for example, a large difference in flowability (melt viscosity) between different forming materials in dies and a large difference in shear rate between the forming materials of the respective layers. Therefore, if the multi-manifold-system dies are used, different materials having a difference in flowability can widely be selected compared with another system (for example, feed-block-system). Screw types of the extruders used in melting of the forming materials may each be monoaxial or biaxial.

The molding temperature in the above-mentioned coextrusion molding is preferably 160° C. to 220° C., more preferably 170° C. to 200° C. If the temperature is in such range, excellent molding stability can be achieved.

A difference in shear viscosity between the above-mentioned heat-resistant layer-forming material or second heat-resistant layer-forming material and the above-mentioned base layer-forming material at a temperature of 180° C. and a shear rate of 100 sec⁻¹ (the heat-resistant layer or second heat-resistant layer-forming material-the base layer-forming material) is preferably −150 Pa·s to 600 Pa·s, more preferably −100 Pa·s to 550 Pa·s, particularly preferably −50 Pa·s to 500 Pa·s. A difference in shear viscosity between the above-mentioned pressure-sensitive adhesive layer-forming material and the above-mentioned base layer-forming material at a temperature of 180° C. and a shear rate of 100 sec⁻¹ (the pressure-sensitive adhesive layer-forming material-the base layer-forming material) is preferably −150 Pa·s to 600 Pa·s, more preferably −100 Pa·s to 550 Pa·s, particularly preferably −50 Pa·s to 500 Pa·s. If the difference is in such range, it is possible to prevent confluence failures because the pressure-sensitive adhesive layer-forming material and the base layer-forming material described above are similar in flowability in dies. It should be noted that the shear viscosity can be measured by a twin capillary extensional rheometer.

### EXAMPLES

Hereinafter, the present invention is described specifically by way of examples. However, the present invention is by no means limited to these examples. It should be noted that in the examples and the like, test and evaluation methods are as described below, and the term “part(s)” means “part(s) by weight.”

### Example 1

A polypropylene-based resin polymerized by using a metallocene catalyst (manufactured by Japan Polypropylene Corporation, product name “WELNEX: RFGV4A”; melting point: 130° C., softening point: 120° C., Mw/Mn=2.9) was used as each of a heat-resistant layer-forming material and a second heat-resistant layer-forming material.

An ethylene-vinyl acetate copolymer (manufactured by DU PONT-MITSUI POLYCHEMICALS, product name “P-1007”; melting point: 94° C., softening point: 71° C.) (100 parts) was used as a base layer-forming material.

An amorphous propylene-(1-butene) copolymer polymerized by using a metallocene catalyst (manufactured by Sumitomo Chemical Co., Ltd., product name “Tafseren HS002”: constituent unit derived from propylene: 90 mol %/constituent unit derived from 1-butene: 10 mol %, Mw=230,000, Mw/Mn=1.8) was used as a pressure-sensitive adhesive layer-forming material.

The heat-resistant layer-forming material (100 parts), base layer-forming material (100 parts), second heat-resistant layer-forming material (100 parts), and pressure-sensitive adhesive layer-forming material (100 parts) described above were separately fed into extruders to perform molding by T-die melt-coextrusion (extrusion temperature: 180° C.), to thereby obtain a pressure-sensitive adhesive tape having a four-type four-layer construction including a heat-resistant layer (thickness: 15 μm)/a base layer (thickness: 70 μm)/a second heat-resistant layer (thickness: 15 μm)/a pressure-sensitive adhesive layer (thickness: 30 μm). It should be noted that the thickness of each layer was controlled by the shape of the outlet of the T-die.

### Example 2

A pressure-sensitive adhesive tape was obtained in the same manner as in Example 1 except that the thickness of the base layer was changed to 145 μm.

### Example 3

A pressure-sensitive adhesive tape was obtained in the same manner as in Example 1 except that the thicknesses of the heat-resistant layer, the base layer, and the second heat-resistant layer were changed to 22.5 μm, 55 μm, and 22.5 μm, respectively.

### Example 4

A pressure-sensitive adhesive tape was obtained in the same manner as in Example 1 except that the thicknesses of the heat-resistant layer, the base layer, and the second heat-resistant layer were changed to 22.5 μm, 130 μm, and 22.5 μm, respectively.

### Example 5

A pressure-sensitive adhesive tape was obtained in the same manner as in Example 1 except that the thicknesses of the heat-resistant layer, the base layer, and the second heat-resistant layer were changed to 30 μm, 40 μm, and 30 μm, respectively.

### Example 6

A pressure-sensitive adhesive tape was obtained in the same manner as in Example 1 except that the thicknesses of the heat-resistant layer, the base layer, and the second heat-resistant layer were changed to 30 μm, 115 μm, and 30 μm, respectively.

### Example 7

A polypropylene-based resin polymerized by using a metallocene catalyst (manufactured by Japan Polypropylene Corporation, product name “WINTEK: WFX4”; melting point: 125° C., softening point: 115° C., Mw/Mn=2.8) was used as a heat-resistant layer-forming material.

An ethylene-vinyl acetate copolymer (manufactured by DU PONT-MITSUI POLYCHEMICALS, product name “P-1007”; melting point: 94° C., softening point: 71° C.) was used as a base layer-forming material.

An amorphous propylene-(1-butene) copolymer polymerized by using a metallocene catalyst (manufactured by Sumitomo Chemical Co., Ltd., product name “Tafseren HS 02”: constituent unit derived from propylene: 90 mol %/constituent unit derived from 1-butene: 10 mol %, Mw=230,000, Mw/Mn=1.8) was used as a pressure-sensitive adhesive layer-forming material.

The heat-resistant layer-forming material (100 parts), base layer-forming material (100 parts), and pressure-sensitive adhesive layer-forming material (100 parts) described above were separately fed into extruders to perform molding by T-die melt-coextrusion (extrusion temperature: 180° C.), to thereby obtain a pressure-sensitive adhesive tape having a three-type three-layer construction including a heat-resistant layer (thickness: 10 μm)/a base layer (thickness: 90 μm)/a pressure-sensitive adhesive layer (thickness: 30 μm).

### Example 8

A pressure-sensitive adhesive tape was obtained in the same manner as in Example 7 except that the thickness of the base layer was changed to 165 μm.

### Example 9

A pressure-sensitive adhesive tape was obtained in the same manner as in Example 7 except that the thickness of the heat-resistant layer was changed to 15 μm, and the thickness of the base layer was changed to 85 μm.

### Example 10

A pressure-sensitive adhesive tape was obtained in the same manner as in Example 7 except that the thickness of the heat-resistant layer was changed to 15 μm, and the thickness of the base layer was changed to 160 μm.

### Example 11

A pressure-sensitive adhesive tape was obtained in the same manner as in Example 7 except that the thickness of the heat-resistant layer was changed to 30 μm, and the thickness of the base layer was changed to 145 μm.

### Example 12

A polypropylene-based resin polymerized by using a metallocene catalyst (manufactured by Japan Polypropylene Corporation, product name “WELNEX: RFGV4A”; meltingpoint: 130° C., softening point: 120° C., Mw/Mn=2.9) was used as a heat-resistant layer-forming material.

An ethylene-vinyl acetate copolymer (manufactured by DU PONT-MITSUI POLYCHEMICALS, product name “P-1007”; melting point: 94° C., softening point: 71° C.) was used as a base layer-forming material.

An amorphous propylene-(1-butene) copolymer polymerized by using a metallocene catalyst (manufactured by Sumitomo Chemical Co., Ltd., product name “Tafseren HS002”: constituent unit derived from propylene: 90 mol %/constituent unit derived from 1-butene: 10 mol %, Mw=230,000, Mw/Mn=1.8) was used as a pressure-sensitive adhesive layer-forming material.

The heat-resistant layer-forming material (100 parts), base layer-forming material (100 parts), and pressure-sensitive adhesive layer-forming material (100 parts) were separately fed into extruders to perform molding by T-die melt-coextrusion (extrusion temperature: 180° C.), to thereby obtain a pressure-sensitive adhesive tape having a three-type three-layer construction including a heat-resistant layer (thickness: 10 μm)/a base layer (thickness: 90 μm)/a pressure-sensitive adhesive layer (thickness: 30 μm).

### Example 13

A pressure-sensitive adhesive tape was obtained in the same manner as in Example 12 except that the thickness of the base layer was changed to 165 μm.

### Example 14

A pressure-sensitive adhesive tape was obtained in the same manner as in Example 12 except that the thickness of the heat-resistant layer was changed to 15 μm, and the thickness of the base layer was changed to 85 μm.

### Example 15

A pressure-sensitive adhesive tape was obtained in the same manner as in Example 12 except that the thickness of the heat-resistant layer was changed to 15 μm, and the thickness of the base layer was changed to 160 μm.

### Example 16

A pressure-sensitive adhesive tape was obtained in the same manner as in Example 12 except that the thickness of the heat-resistant layer was changed to 30 μm, and the thickness of the base layer was changed to 70 μm.

### Example 17

A pressure-sensitive adhesive tape was obtained in the same manner as in Example 12 except that the thickness of the heat-resistant layer was changed to 30 μm, and the thickness of the base layer was changed to 145 μm.

### Example 18

A pressure-sensitive adhesive tape was obtained in the same manner as in Example 12 except that the thickness of the heat-resistant layer was changed to 45 μm, and the thickness of the base layer was changed to 55 μm.

### Example 19

A pressure-sensitive adhesive tape was obtained in the same manner as in Example 12 except that the thickness of the heat-resistant layer was changed to 45 μm, and the thickness of the base layer was changed to 130 μm.

### Example 20

A pressure-sensitive adhesive tape was obtained in the same manner as in Example 12 except that the thickness of the heat-resistant layer was changed to 60 μm, and the thickness of the base layer was changed to 40 μm.

### Example 21

A pressure-sensitive adhesive tape was obtained in the same manner as in Example 12 except that the thickness of the heat-resistant layer was changed to 60 μm, and the thickness of the base layer was changed to 115 μm.

### Comparative Example 1

A pressure-sensitive adhesive tape was obtained in the same manner as in Example 1 except that the heat-resistant layer was not formed, and the thickness of the base layer was changed to 100 μm.

### Comparative Example 2

A pressure-sensitive adhesive tape was obtained in the same manner as in Example 1 except that the heat-resistant layer was not formed, a polypropylene-based rein polymerized by using a metallocene catalyst (manufactured by Japan Polypropylene Corporation, product name “WINTEC WFX4”: melting point: 125° C., softening point: 115° C.) was used as the base layer-forming material instead of the ethylene-vinyl acetate copolymer (manufactured by DUPONT-MITSUI POLYCHEMICALS, product name “P-1007”; melting point: 94° C., softening point: 71° C.), and the thickness of the base layer was changed to 100 μm.

### Evaluation

The pressure-sensitive adhesive tapes obtained in Examples and Comparative Examples were subj ected to the following evaluation. Table 1 shows the results.

### (1) Heat Resistance

The pressure-sensitive adhesive tapes obtained in Examples and Comparative Examples were each attached to a semiconductor wafer (8-inch mirror wafer, thickness: 700 μm), and the pressure-sensitive adhesive tape side was placed on a hot plate (SUS 304) heated to 100° C. and heated for three minutes. In this procedure, the tape was placed so that the outermost layer opposite to the pressure-sensitive adhesive layer of the pressure-sensitive adhesive tape had contact with the heating surface. After completion of heating, the state of the pressure-sensitive adhesive tape was visually observed to evaluate its heat resistance based on the following criteria.

∘: High heat resistance with no change in the outermost layer of the pressure-sensitive adhesive tape.

Δ: Poor heat resistance with partial melting in the outermost layer of the pressure-sensitive adhesive tape.

X: Very poor heat resistance with fusion of the pressure-sensitive adhesive tape on the hot plate.

### (2) Elastic Modulus

The pressure-sensitive adhesive tapes obtained in Examples and Comparative Examples were each cut into a strip with a width of 10 mm, and the strip was stretched at 23° C., a distance between chucks of 50 mm, and a rate of 300 mm/min, using a triple tensile tester AG-IS (manufactured by Shimadzu Corporation) as a tensile tester. The elastic modulus was calculated from a slope of the maximum tangent in a stress-strain (S-S) curve thus obtained.

### (3) Damage in Semiconductor Wafer

The pressure-sensitive adhesive tapes obtained in Examples and Comparative Examples were each attached on an 8-inch semiconductor wafer (thickness: 700 μm to 750 μm) on which steps each with a height of 10 μm (10 mm×10 mm square) were randomly created, and the semiconductor wafer side (the surface opposite to the pressure-sensitive adhesive tape-attached surface) was ground. The wafer was ground by a back grinder (manufactured by DISCO Corporation, DFG-8560) until the thickness of the 8-inch Si mirror wafer reached 50 μm. After that, damage in the semiconductor wafer periphery, such as chap, crack, and defect which can be visually observed, were visually observed. Ten semiconductor wafers were evaluated by observing such damage based on the following criteria.

∘: Of the ten wafers, the damage was observed in 0 wafers.

Δ: Of the ten wafers, the damage was observed in 1 or more and 3 or less wafers.

x: Of the ten wafers, the damage was observed in 4 or more wafers.

### (4) Contamination Property

The pressure-sensitive adhesive tapes were each attached on a mirror surface of a 4-inch semiconductor wafer and peeled off after a lapse of one hour under an environment of a temperature of 23° C. and a relative humidity of 50%, and the number of particles having particle sizes of 0.28 μm or more on the mirror surface was measured. The number of the particles was measured using a particle counter (manufactured by KLA-Tencor Corporation, product name “SURFSCAN 6200”).

### (5) Amount of Ion Contained

Amounts of analyte ions (F⁻, Cl⁻, Br⁻, NO₂⁻, NO₃⁻, SO₄²⁻, Li⁺, Na⁺, K⁺, Mg²⁺, Ca²⁺, and NH₄⁺) in the pressure-sensitive adhesive tapes obtained in Examples and Comparative Examples were measured by ion chromatography.

Specifically, a test specimen (1 g of the pressure-sensitive adhesive tape) placed in a polymethylpentene (PMP) container was weighed, and 50 ml of pure water were added thereto. Then, the container was covered with a lid and placed in a drying machine to perform heating extraction at 120° C. for 1 hour. The extract was filtrated using a cartridge for sample pretreatment (manufactured by DIONEX, product name “On Guard II RP”), and the filtrate was subjected to measurement by ion chromatography (anion) (manufactured by DIONEX, product name “DX-320”) and by ion chromatography (cation) (manufactured by DIONEX, product name “DX-500”). Detection limits of this measurement method were found to be 0.49 μg or less for each of F⁻, Cl⁻, Br⁻, NO₂⁻, NO₃⁻, SO₄²⁻, and K⁺, 0.20 μg or less for each of Li⁺ and Na⁺, 0.97 μg or less for each of Mg²⁺ and Ca²⁺, and 0.50 μg or less for NH₄⁺ with respect to 1 g of the pressure-sensitive adhesive tape.

### (6) Measurement of Molecular Weight

The molecular weight of the amorphous propylene-(1-butene) copolymer polymerized by using the metallocene catalyst (manufactured by Sumitomo Chemical Co., Ltd., product name “Tafseren HS002”) used in each of Examples and Comparative Examples was measured as follows. That is, a sample (1.0 g/l THF solution) was prepared, allowed to stand still overnight, and filtrated using a membrane filter with a pore size of 0.45 μm, and the resultant filtrate was subjected to measurement using HLC-8120 GPC manufactured by TOSOH Corporation under the following conditions. The molecular weight was calculated in terms of polystyrene.

Column: TSKgel Super HZM-H/HZ4000/HZ3000/HZ2000

Column size: 6.0 mm I.D.×150 mm

Column temperature: 40° C.

Eluent: THF

Flow rate: 0.6 ml/min

Injection amount: 20 μl

Detector: refractive index detector (RI)

Meanwhile, the molecular weight of the crystalline polypropylene-based resin polymerized by using the metallocene catalyst (manufactured by Japan Polypropylene Corporation, product name “WINTEC WFX4”) used in each of Examples 7 to 11 and Comparative Example 2 was measured as follows. That is, a sample (0.10% (w/w) o-dichlorobenzene solution) was prepared and dissolved at 140° C., and the solution was filtrated by a sintered filter with a pore size of 1.0 μm. The resultant filtrate was subjected to measurement by a gel permeation chromatograph Alliance GPC type 2000 manufactured by Waters under the following conditions. The molecular weight was calculated in terms of polystyrene.

Column: TSKgel GMH₆-HT, TSKgel GMH₆-HTL

Column size: two columns of 7.5 mm I.D.×300 mm size for each type

Column temperature: 140° C.

Eluent: o-dichlorobenzene

Flow rate: 1.0 ml/min

Injection amount: 0.4 ml

Detector: refractive index detector (RI)

TABLE 1

| | | Example | Example | Example | Example | Example | Example |
|---|---|---|---|---|---|---|---|
| | | 1 | 2 | 3 | 4 | 5 | 6 |
| Heat-resistant | Material name | RFG4VA | RFG4VA | RFG4VA | RFG4VA | RFG4VA | RFG4VA |
| layer | Thickness (μm) | 15 | 15 | 22.5 | 22.5 | 30 | 30 |
| Base layer | Material name | P-1007 | P-1007 | P-1007 | P-1007 | P-1007 | P-1007 |
| | Thickness (μm) | 70 | 145 | 55 | 130 | 40 | 115 |
| Second | Material name | RFG4VA | RFG4VA | RFG4VA | RFG4VA | RFG4VA | RFG4VA |
| heat-resistant | Thickness (μm) | 15 | 15 | 22.5 | 22.5 | 30 | 30 |
| layer | | | | | | | |
| Pressure- | Material name | H5002 | H5002 | H5002 | H5002 | H5002 | H5002 |
| sensitive adhesive | Thickness (μm) | 30 | 30 | 30 | 30 | 30 | 30 |
| layer | | | | | | | |
| Evaluation | Heat resistance | ∘ | ∘ | ∘ | ∘ | ∘ | ∘ |
| | Elastic modulus (MPa) | 94 | 93 | 118 | 107 | 134 | 112 |
| | Wafer-damaging property | ∘ | ∘ | ∘ | ∘ | ∘ | ∘ |
| | Contamination property | 3.6 | 3.7 | 3.7 | 3.8 | 4.5 | 3.8 |
| | (number of particles) | | | | | | |
| | (particles/cm²) | | | | | | |
| | Amount of ion Ion species: | — | — | — | — | — | — |
| | amount of ion detected | | | | | | |
| | (In the case where the amount | | | | | | |
| | of ion is smaller than the | | | | | | |
| | detection limit, the result | | | | | | |
| | is shown by “—”.) | | | | | | |

| | | Example | Example | Example | Example | Example |
|---|---|---|---|---|---|---|
| | | 7 | 8 | 9 | 10 | 11 |
| Heat-resistant | Material name | WFX4 | WFX4 | WFX4 | WFX4 | WFX4 |
| layer | Thickness (μm) | 10 | 10 | 15 | 15 | 30 |
| Base layer | Material name | P-1007 | P-1007 | P-1007 | P-1007 | P-1007 |
| | Thickness (μm) | 90 | 165 | 85 | 160 | 145 |
| Second | Material name | — | — | — | — | — |
| heat-resistant | Thickness (μm) | — | — | — | — | — |
| layer | | | | | | |
| Pressure- | Material name | H5002 | H5002 | H5002 | H5002 | H5002 |
| sensitive adhesive | Thickness (μm) | 30 | 30 | 30 | 30 | 30 |
| layer | | | | | | |
| Evaluation | Heat resistance | ∘ | ∘ | ∘ | ∘ | ∘ |
| | Elastic modulus (MPa) | 101 | 83 | 115 | 105 | 120 |
| | Wafer-damaging property | ∘ | ∘ | ∘ | ∘ | ∘ |
| | Contamination property | 3.9 | 3.7 | 5.3 | 4.2 | 4.1 |
| | (number of particles) | | | | | |
| | (particles/cm²) | | | | | |
| | Amount of ion Ion species: | — | — | — | — | — |
| | amount of ion detected | | | | | |
| | (In the case where the amount | | | | | |
| | of ion is smaller than the | | | | | |
| | detection limit, the result | | | | | |
| | is shown by “—”.) | | | | | |

| | | Example | Example | Example | Example | Example | Example | Example |
|---|---|---|---|---|---|---|---|---|
| | | 12 | 13 | 14 | 15 | 16 | 17 | 18 |
| Heat-resistant | Material name | RFG4VA | RFG4VA | RFG4VA | RFG4VA | RFG4VA | RFG4VA | RFG4VA |
| layer | Thickness (μm) | 10 | 10 | 15 | 15 | 30 | 30 | 45 |
| Base layer | Material name | P-1007 | P-1007 | P-1007 | P-1007 | P-1007 | P-1007 | P-1007 |
| | Thickness (μm) | 90 | 165 | 85 | 160 | 70 | 145 | 55 |
| Second | Material name | — | — | — | — | — | — | — |
| heat-resistant | Thickness (μm) | — | — | — | — | — | — | — |
| layer | | | | | | | | |
| Pressure- | Material name Main resin | H5002 | H5002 | H5002 | H5002 | H5002 | H5002 | H5002 |
| sensitive adhesive | Thickness (μm) | 30 | 30 | 30 | 30 | 30 | 30 | 30 |
| layer | | | | | | | | |
| Evaluation | Heat resistance | ∘ | ∘ | ∘ | ∘ | ∘ | ∘ | ∘ |
| | Elastic modulus (MPa) | 72 | 67 | 74 | 71 | 93 | 92 | 116 |
| | Wafer-damaging property | ∘ | ∘ | ∘ | ∘ | ∘ | ∘ | ∘ |
| | Contamination property | 3.6 | 3.4 | 3.5 | 3.5 | 3.8 | 4.2 | 4.5 |
| | (number of particles) | | | | | | | |
| | (particles/cm²) | | | | | | | |
| | Amount of ion Ion species: | — | — | — | — | — | — | — |
| | amount of ion detected | | | | | | | |
| | (In the case where the amount | | | | | | | |
| | of ion is smaller than the | | | | | | | |
| | detection limit, the result | | | | | | | |
| | is shown by “—”.) | | | | | | | |

| | | Example | Example | Example | Comparative | Comparative |
|---|---|---|---|---|---|---|
| | | 19 | 20 | 21 | Example 1 | Example 2 |
| Heat-resistant | Material name | RFG4VA | RFG4VA | RFG4VA | — | — |
| layer | Thickness (μm) | 45 | 60 | 60 | — | — |
| Base layer | Material name | P-1007 | P-1007 | P-1007 | P-1007 | WFX4 |
| | Thickness (μm) | 130 | 40 | 115 | 100 | 100 |
| Second | Material name | — | — | — | — | — |
| heat-resistant | Thickness (μm) | — | — | — | — | — |
| layer | | | | | | |
| Pressure- | Material name Main resin | H5002 | H5002 | H5002 | H5002 | H5002 |
| sensitive adhesive | Thickness (μm) | 30 | 30 | 30 | 30 | 30 |
| layer | | | | | | |
| Evaluation | Heat resistance | ∘ | ∘ | ∘ | x | 0 |
| | Elastic modulus (MPa) | 103 | 131 | 109 | 68 | 510 |
| | Wafer-damaging property | ∘ | ∘ | ∘ | ∘ | x |
| | Contamination property | 3.5 | 3.2 | 4.1 | 3.2 | 3.4 |
| | (number of particles) | | | | | |
| | (particles/cm²) | | | | | |
| | Amount of ion Ion species: | — | — | — | — | — |
| | amount of ion detected | | | | | |
| | (In the case where the amount | | | | | |
| | of ion is smaller than the | | | | | |
| | detection limit, the result | | | | | |
| | is shown by “—”.) | | | | | |

As is clear from a comparison between Examples and Comparative Example 1, according to the invention of this application, it is possible to provide a pressure-sensitive adhesive tape having excellent heat resistance because the tape includes the heat-resistant layer containing a specific polypropylene-based resin. Meanwhile, as is clear from a comparison between Examples and Comparative Example 2, the elastic modulus of the pressure-sensitive adhesive tape of the present invention can be controlled by adjusting the thickness of each layer because the tape has a three-layer structure including the heat-resistant layer, base layer, and pressure-sensitive adhesive layer, or a four-layer structure further including the second heat-resistant layer. As a result, the pressure-sensitive adhesive tape of the present invention exhibits excellent flexibility, and in the case of using the tape as a pressure-sensitive adhesive tape for processing a semiconductor wafer, it is possible to prevent damage in the wafer.

The pressure-sensitive adhesive tape of the present invention can be suitably used in, for example, the protection of a workpiece (such as a semiconductor wafer) upon production of a semiconductor apparatus.

What is claimed is:

1. A pressure-sensitive adhesive tape, comprising:
a heat-resistant layer;
a base layer; and
a pressure-sensitive adhesive layer in this order, wherein:
the pressure-sensitive adhesive tape has an elastic modulus, i.e., Young's modulus at 25° C. of 150 MPa or less; and
the heat-resistant layer contains a polypropylene-based resin polymerized by using a metallocene catalyst, the polypropylene-based resin having a melting point of 110° C. to 200° C. and a molecular weight distribution “Mw/Mn” of 3 or less.

2. A pressure-sensitive adhesive tape according to claim 1, further comprising a second heat-resistant layer between the base layer and the pressure-sensitive adhesive layer.

3. A pressure-sensitive adhesive tape according to claim 1, wherein the heat-resistant layer is substantially free of F⁻, Cl⁻, Br⁻, NO₂⁻, NO₃⁻, SO₄²⁻, Li⁺, Na⁺, K⁺, Mg²⁺, Ca²⁺, and NH₄⁺.

4. A pressure-sensitive adhesive tape according to claim 2, wherein the heat-resistant layer is substantially free of F⁻, Cl⁻, Br⁻, NO₂⁻, NO₃⁻, SO₄²⁻, Li⁺, Na⁺, K⁺, Mg²⁺, Ca²⁺, and NH₄⁺.

5. A pressure-sensitive adhesive tape according to claim 1, which is obtained by coextrusion molding of a heat-resistant layer-forming material, a base layer-forming material, and a pressure-sensitive adhesive layer-forming material.

6. A pressure-sensitive adhesive tape according to claim 2, which is obtained by coextrusion molding of a heat-resistant layer-forming material, a base layer-forming material, and a pressure-sensitive adhesive layer-forming material.

7. A pressure-sensitive adhesive tape according to claim 1, wherein the pressure-sensitive adhesive tape is used for processing a semiconductor wafer.
